(19) United States
(12) Patent Application Publication
(10) Pub. No.: US 2017/0126901 A1
(43) Pub. Date: May 4, 2017

(54) METHODS AND SYSTEMS FOR PROCESSING CALL ESTABLISHMENT REQUEST

(71) Applicant: Chu Kiat Lim, Selangor Darul Ehsan (MY)

(72) Inventor: Chu Kiat Lim, Selangor Darul Ehsan (MY)

(21) Appl. No.: 15/318,280

(22) PCT Filed: Jun. 12, 2015
(86) PCT No.: PCT/MY2015/000047

§ 371 Date: Dec. 12, 2016

(30) Foreign Application Priority Data
Jun. 12, 2014 (MY) PI 2014701573

(51) Int. Cl. H04M 15/08; H04M 15/00

(52) U.S. Cl. CPC H04M 15/08; H04M 15/8038; H04M 15/60

(57) ABSTRACT

A system (200) and method (300) for establishing a call from an Originating subscriber in an Originating network (203) to a Terminal subscriber (207) in a Terminal network (204) is provided. The method includes establishing a call by the Originating subscriber (206) in the Originating network (203) to the Terminal subscriber (207) in the Terminal network (204); bridging the calls between the Originating network (203) and Terminal network (204) via the automated Switching Centre (201); and triggering the Terminal network (204) to charge the Terminal subscriber (207) for the call.

### FIELD OF INVENTION

The invention relates to called party and third party charging requested by calling party in processing call establishment requests in telecommunication systems and particularly to independently administered networks is disclosed.

### BACKGROUND OF THE INVENTION

Prepaid telecommunication services is a popular way which allows the user to pre-purchase credit with a particular telecommunications company for the consumption of telecommunication services, most commonly for the making of voice calls by a Calling Party to a Called Party. The prepaid system is commonly implemented in various mobile, fixed networks and calling card providers around the world. Typically the deduction logic or deduction policy of the prepaid value is determined beforehand solely by the telecommunication service provider which the subscriber belongs to and is applied in real time by deducting the prepaid values of their subscribers stored in their respective network databases.

In contrary, for postpaid users, the users in this situation are billed after the fact according to their use of telecommunication services at the end of each billing period. This is done by inserting call details into the bill for the postpaid users so that they can pay for the usage at a later stage.

A Collect call is a phone call in which the Called party (receiver) pays the charges, rather than the Calling party, as is conventional. Collect calling across multiple independently administered network, especially across international boundaries, is traditionally implemented for Called Parties being postpaid subscribers only as there is no function for real time deduction of prepaid values from the Called party's network. When a Collect Call is placed to a postpaid receiver, the Originating network simply takes a record of the call duration and related data and the postpaid receiver's network takes note of the same and inserts the details into the postpaid receiver's bill. Postpaid Called Party Collect. calling has been implemented in regions of the world such as Australia, France, Spain, Ireland, United Kingdom, USA and Canada, historically, when human operator assisted calling was the standard way of placing an international call rather than direct dialing. The process for making a Collect call varies depending on the nation, but can usually be accomplished by dialing an access code for the operator, and requesting that the operator to put through a Collect call. When Calling party makes a Collect call, the phone rings on the Called party, and if the Called party answers the call, the Called party is informed that someone is attempting to make a Collect call to the Called party. If the Called party accepts the call and the associated charges, the Calling party will be put through. With the availability of mobile roaming in modern telecommunication networks, the charges for Collect calls can be prohibitive as during the confirmation-for-acceptance phase of the Collect call, as the Called Party has already been roaming in a visiting network, and to be able to confirm acceptance of the call, the visiting network must have fully established the call and would have charged the Called Party's home network for the connection even if the Called Party refuses the acceptance of the Collect call. Thus providing telecommunication service such as Collect call service across independently administered telecommunication network is difficult in terms of call charges, deduction and connection establishment.

In a prepaid Called party environment, conventional method of transferring credit or deduction of prepaid value for Collect calls is typically done when both the Calling Party and Called party belong to the same administer, i.e. the same administrator does a logical deduction on its own database, and accessing the same database administered by a single telecommunications service provider entity for both. Instead of deducting from the requester of the service, i.e. in the case of a voice call, the Calling party, the logic of service deducts the terminal or receiving party, i.e. the Called party of its prepaid value all within the same database administered by one telecommunication service provider.

With the availability of number portability in some networks where the mobile subscriber retains its number when it changes his home network service provider, it is not straightforward to determine to which network the call system is to direct the routing for call establishment and call charging.

Accordingly, it would be desirable for improved methods and systems for providing second and third party charging for telecommunication services across independently administered networks.

### SUMMARY OF THE INVENTION

The present invention has been made in the view of the above problems, and it is an object of the present invention to provide second and third party charging for telecommunication services across independently administered networks.

In an aspect, a method (300) for establishing a call from an Originating subscriber in an Originating network to a Terminal subscriber in a Terminal network is provided. The method includes establishing a call by the Originating subscriber in the Originating network to the Terminal subscriber in the Terminal network; bridging the calls between the Originating network and Terminal network via the automated Switching Centre; and triggering the Terminal network to charge the Terminal subscriber for the call.

In another aspect, a method (400) for establishing a call from Originating subscriber from an Originating network to Terminal subscriber from a Terminal network, sponsored by a third party from a Sponsor network, by a Switching Centre is provided. The method includes establishing a call by the Originating subscriber at the Originating network to the Terminal subscriber at the Terminal network; bridging the calls between the Originating network and Terminal network via the automated Switching Centre; and triggering the sponsor network to charge the sponsor subscriber for the call.

In yet another aspect, a system (200) for establishing a call from an originating subscriber in an Originating network to a Terminal subscriber in a Terminal network, wherein the terminal subscriber is charged for the call, is provided. The system includes a Switching Centre (201) that communicates with VoIP gateways and TDM gateways or equivalent systems of the Originating and Terminal network.

In still another aspect, the Switching Centre includes an access Detection & Triggering Subsystem (501) that detects a request for initiation of service, e.g. a voice call and commences the service delivery and charging functions provided by the system; a Service Data Collection Subsystem (502) that facilitates the collection of additional information necessary for the service logic to proceed to a next stage; a Routing Logic Subsystem (503) that determines a network for charging purposes and for routing of calls to a selected network; an acceptance of Charge Subsystem (509) that handles the confirmation by the Terminal or Sponsor party to accept the charges; and an External Prepaid Value Query & Interface Subsystem (512) that queries a Sponsor or Terminal network for the prepaid balance of the Sponsor or Terminal subscriber for a particular request, and facilitating the charging of the service at the Terminal or Sponsor network.

### BRIEF DESCRIPTION OF DRAWINGS

Other objects, features, and advantages of the invention will be apparent from the following description when read with reference to the accompanying drawings. In the drawings, wherein like reference numerals denote corresponding parts throughout the several views:

FIG. 1 is an overview of the system showing different parties and networks;

FIG. 2 illustrates an overview of implementation system for provision of Called-party-charged and third-party-charged functionality for Calling party initiated call;

FIG. 3 is a signaling chart of the first embodiment of the method according to the present invention;

FIG. 4 is a signaling chart of another embodiment of the method according to the present invention;

FIG. 5 illustrates the different components of the switching centre.

### DETAILED DESCRIPTION OF THE PREFERRED EMBODIMENTS

Reference will now be made in detail to the preferred embodiments of the present invention, examples of which are illustrated in the accompanying drawings.

The invention relates to Called party and third party charging requested by Calling party in processing call establishment requests in telecommunication systems and particularly to independent administered networks is disclosed.

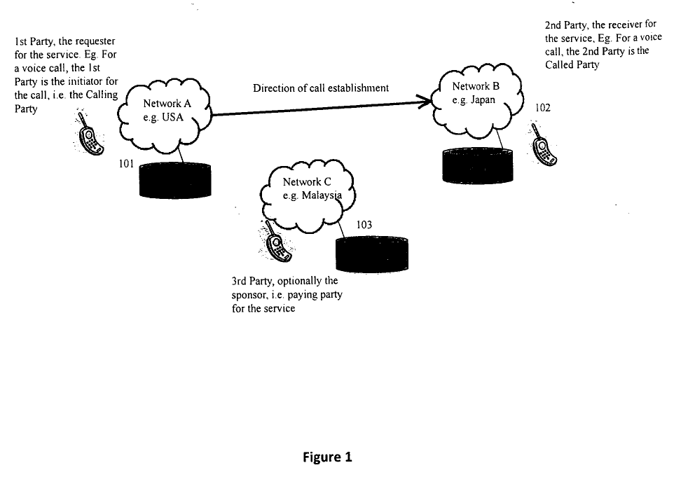

FIG. 1 is an overview of the system showing different parties and networks. The first party (101) also called as Calling party or Originating subscriber registered to Originating network in a geographical coverage area. The first party (101) is the requestor for the service or initiator for the call, for example, voice call. The second party (102) also called as Called party or Terminal subscriber, called as receiver of the initiation for the service. The service referred to here is the Collect call service. According embodiments described herein, a network at the receiving end of the call establishment is called a Terminal Network. The third party (103) also called as Sponsor party, optionally sponsors the call established between Called party and Calling party. The third party (103) is registered on his/her own network called as Sponsor Network. The Sponsor network can be an Originating network or Terminal network or other than both.

According to an embodiment, the Calling party (101), Called party (102) and Sponsor party (103) are registered in their respective independently administered network typically can be the same or different geographical location. For example, the Calling party (101) geographic location is USA, Called party (102) is Japan and Sponsor party (103) is Malaysia. In this invention, it is not a limiting factor to allow the Calling party (101), Called party (102) or Sponsor party (103) to be registered to the same network.

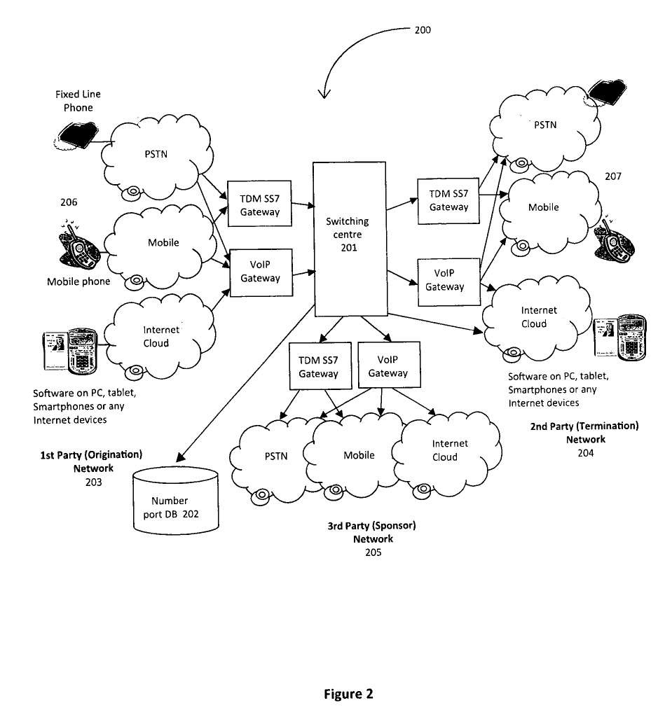

FIG. 2, illustrates an overview of implementation system for provision of Called-party-charged and third-party-charged functionality for Calling party initiated call. The overview of the implementation system having a Switching Centre (201) connected to different networks via conventional gateways and signaling methods. The Switching Centre (201) allows establishing the traditional voice call or VoIP (voice over internet protocol) calls to and between different networks such as Originating network, Terminal network and Sponsor network. The Switching Centre may be connected to one or many portability number databases (202), which stores the information of the associated numbers belonging to particular networks. The portability number databases can be an internal or external databases administered by an external provider. The Switching Centre (201) if in the event failed to deduce the Called Party or third Party network from subscriber number analysis or MAP (mobile application part) signaling message deduction or other methods, can send the query to the database to know the target network of the respective numbers. In FIG. 2 the SS7 signaling can be interconnected to a mobile network using for example, the MAP signaling for the query of the location of a particular mobile station. The SS7 transport can be via traditional TDM (time division multiplexed) signaling system 7 connectivity or through IP transport such as SIGTRAN. In this invention, it is not a limiting factor if the Origination or Terminal equipment is a mobile phone, pc, smart phones, VoIP hardware, software phones or tablet devices.

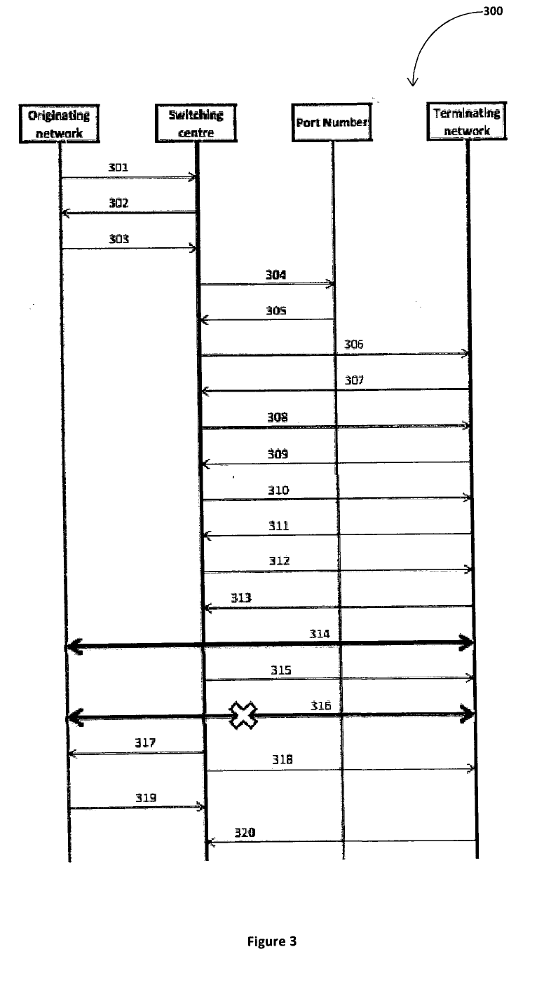

FIG. 3 is a signaling chart of the first embodiment of the method according to the present invention. A system and method (300) for establishing a call from Calling party from an Originating network to Called party from a Terminal network by a switching centre is illustrated. In the FIG. 3 the flow of exchange of messages between Originating network, Switching Centre and Terminal network and portability database is illustrated. In step 301 an initial call is established with the Switching Centre by the Originating network. In the case of SS7 network, this will be the IAM (initial address message) or in the case of a SIP VoIP network, a SIP INVITE message. During the initial call establishment, the Originating network may or may not be charged depending on the message sent in step 302. In step 302, in situations such as the Called Number is passed along by the Originating network in Step 301, the acknowledge message will be an SS7 ACM (address complete message) or SIP 100 TRYING message followed by SIP 180 RINGING message. In step 302, in the case that the Called Number is not passed along by the Originating network in Step 301 and that the Called number is required to be keyed in by the user, the acknowledge message will be an SS7 ANM (answer message) or SIP 200 OK message. Subsequently, an announcement prompt requesting for the Caller to key in the Called number will be played by the Switching Centre, to request the caller to key in the Called number via DTMF touch tones on the phone keypad in Step 303. In addition the Switching Center may request the Caller to record their voice as an identification to be played to the Called party as identification. In step 304, the Switching Centre sends a request to the Number Portability Database for terminal network information for the Called Party if number portability data is required to determine the actual terminal network for the routing of call. In step 305, if the request 304 is made then the number portability database returns the confirmation of the Terminal network information. In step 306, the Switching Centre queries the Terminal network to check that the terminal subscriber is roaming or not. This is done by sending a MAP SRI (send routing information) message to the Terminal network's HLR or other signaling means. As an alternative to step 304, the Terminal network may also be deduced from the reply of the SRI message. In step 307 Switching Centre receives the confirmation of the whether the subscriber is roaming or not through the response of MAP SRI. If the subscriber is not roaming or the service allows a roaming Called Party subscriber to receive a request-to-acceptance-of-charge call while roaming, then the subsequent step 308 will execute, otherwise an “unreachable” announcement will be played to the Calling Party and the call will drop. In step 308, the Switching Centre sends a trigger to the Terminal network to inquire the prepaid balance of the Called Party or indicate to the network that the Called party will be called and that charging may be expected. In CAMEL, the trigger IDP (Initial Detection Point) is sent to the SCP (Service Control Point) of the Terminal network for this step. In Diameter, a CHECK_BALANCE request can be sent to query the balance of the Terminal subscriber through the Diameter Ro reference point. In step 309, the Terminal network returns a confirmation in the form of Continue instruction or information of the Called Party's prepaid balance. In step 310, Switching Centre sets up call to the Called Party at the Terminal network. In step 311, the Called party answers the call. In step 312, Switching Centre through an interactive voice response (IVR) unit prompts a voice announcement on the Called phone regarding the Collect call from a number and request for confirmation for acceptance of the said call by the means of depression of keys or voice recognition. For example, “you have a collect call from xxx-xxx-xxxx, press 1 to accept”. In step 313, the Called party types a designated key on the keypad to confirm acceptance. In step 314, the switching centre bridges the voice call between Originating subscriber and Terminal subscriber to allow them to speak.

In an embodiment, in step 315, trigger messages are sent to the Terminal network to facilitate charging at the beginning, end and/or during when the conversation is taking place. For example, CAMEL, the ERB (Event Report BCSM) or in Diameter, the CCR (Credit Control Request) messages. In step 316, during the voice call if the prepaid balance has been depleted, the Switching Centre will drop the call connections, sometimes in response to triggers from the Terminal network's SCP (Service Control Point), and other times the determination of prepaid balance talk time within the Switching Centre. In steps 317 and 318, the switching centre releases the call to Originating subscriber and Terminal subscriber. In steps 319 and 320 the switching centre receives the release complete confirmation from Originating subscriber and Terminal subscriber. Alternately, either Calling or Called parties may initiate the hang-up at any time and that the Switching Centre will correspondingly release the call to the other Party, and correspondingly signals to the Terminal network to facilitate end of charge. The access or setup can be through a service prefix added to the Called subscriber number (e.g. dialing 333+Called number) or dialing a specific service number or toll-free number, or accepting a call directly from a VoIP SBC (Session Border Controller), SIP Proxy server or VoIP Softswitch.

In the case of pre-configured implicit approval for acceptance of charges, there is no need to have a set-up call to the Terminal network for explicit acceptance of charges, i.e. Steps 312 and 313.

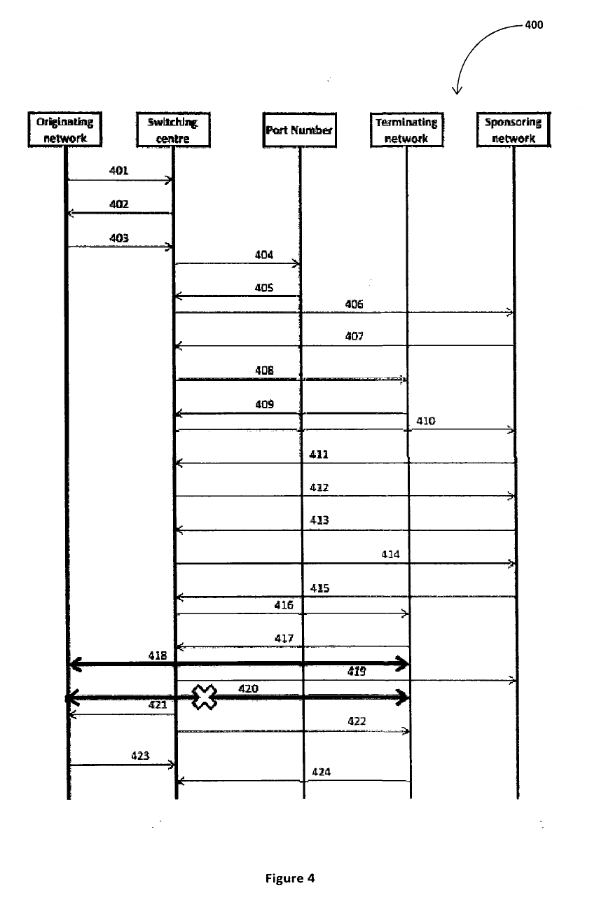

FIG. 4 is a signaling chart of another embodiment of the method according to the present invention. A system and method for establishing a call from Calling party from an Originating network to Called party from a Terminal network, sponsored by a third party from a Sponsor network, by a Switching Centre is illustrated. In the FIG. 4, the flow of exchange of messages between Originating network, Switching Centre, Sponsor network, Terminal network and number portability database is illustrated. In step 401, an initial call is established with the switching centre by the Originating network. In the case of SS7 network, this will be the IAM (Initial Address Message) or in the case of a SIP VoIP network, a SIP INVITE message. During the initial call establishment, the Originating network may or may not be charged depending on the message sent in step 402. In step 402 in situations such as in the case that the Called Number is passed along call by the Originating network and that the Sponsor party has prior approval of acceptance-of-charge to sponsor the call between Calling party and Called party, then in Step 402, the acknowledge message will be an SS7 ACM (address complete message) or SIP 100 TRYING message followed by SIP 180 RINGING message. In step 402, in the case that either or both of the Sponsor number and Called number need to be requested from the Calling party through DTMF input, then the acknowledge message (402) will be an SS7 ANM (answer message) or SIP 200 OK message. Subsequently in Step 403 an announcement prompt requesting for the Calling Party to key in the either or both the Sponsor Number and Called number via DTMF touch tones on the phone keypad will be played by the Switching Centre. In Step 403, the Calling Party keys in the necessary numbers via DTMF touch tones on the phone keypad. In addition the Switching Center may request the Calling Party to record their voice as an identification to be played to the Called party and/or Sponsor party as identification. In step 404, the Switching Centre sends a request to the Number Portability Database for Terminal network information for the Called Party and/or Sponsor party if number portability data is required to determine the actual terminal network for the routing of call. In step 405, if the request 404 is made then the Number Portability database returns the confirmation of the Terminal and sponsoring network information. In step 406, the Switching Centre queries the Sponsor network to check that the Sponsoring subscriber is roaming or not. This is done by sending a MAP SRI (send routing information) message to the Sponsor networks' HLR or other signaling means. In step 407 switching centre receives the confirmation of whether the Sponsoring subscriber is roaming or not through the response of MAP SRI. In step 408, the Switching Centre queries the Terminal network to check that the Terminal subscriber is roaming or not. This is done by sending a MAP SRI (send routing information) message to the Terminal networks' HLR or other signaling means. In step 409 Switching Centre receives the confirmation of whether the Terminal subscriber is roaming or not through the response of MAP SRI. If the Sponsor party is not roaming or the service allows a roaming Sponsor Party subscriber to receive a request-to-acceptance-of-charge call while roaming, and if the Terminal party is not roaming or the service allows a roaming Called Party subscriber to receive an inbound call, then the subsequent step 410 will execute, otherwise an “unreachable” announcement will be played to the Calling Party and the call will drop. In Step 410, the Switching Centre sends a trigger to the sponsoring network to indicate to the network that the sponsoring party that charging may be expected. In CAMEL, the trigger IDP (Initial Detection Point) is sent to the SCP (Service Control Point) of the Terminal network for this step. In Diameter, a CHECK_BALANCE request can be sent to query the balance of the Terminal subscriber through the Diameter Ro reference point. In step 411, the Sponsor network returns a confirmation in the form of Continue instruction or the subscriber's credit balance information. In step 412, Switching Centre sets up call to Sponsor subscriber at the Sponsor network. In step 413, the Sponsor answer the call. In step 414, through an interactive voice response (IVR) unit a voice announcement prompts the Sponsor phone regarding the Sponsor call between the Calling Number and Called Number and request for confirmation for acceptance of the said call by the means of depression of keys or voice recognition. For example “Subscriber number XXX wants to call XXXX. If you are willing to pay for the call, please press “1”. In step 415, the Sponsor types a designated key on the keypad to confirm acceptance and agree on the charge. In step 416, the Switching Centre sets up call to Called Party at Terminal network. In step 417, the Called party subscriber answers the incoming call, hence the voice call is established. In step 418, the Switching Centre bridges the voice call between Originating subscriber and Terminal subscriber to allow them to speak.

In an embodiment, in step 419, trigger messages are sent to the Sponsor network to facilitate charging at the beginning, end and/or during when the conversation is taking place. For example, in CAMEL, the ERB (Event Report BCSM) or in Diameter, the CCR (Credit Control Request) messages In step 420, during the voice call the balance of the Sponsor has been depleted, the Switching Centre will drop the call connections, sometimes in response to triggers from the Sponsor network's SCP (Service Control Point) and other times the determination of prepaid balance talk time within the Switching Centre. In steps 421 and 422 the Switching Centre releases the calls. In steps 423 and 424, the Switching Centre receives the release complete confirmation from Originating and Terminal subscribers' network. Alternately, either Calling or Called parties may initiate the hang-up at any time and that the Switching Centre will release the calls to the Originating Party and Terminal Party and correspondingly signals to the Sponsor network to facilitate end of charge.

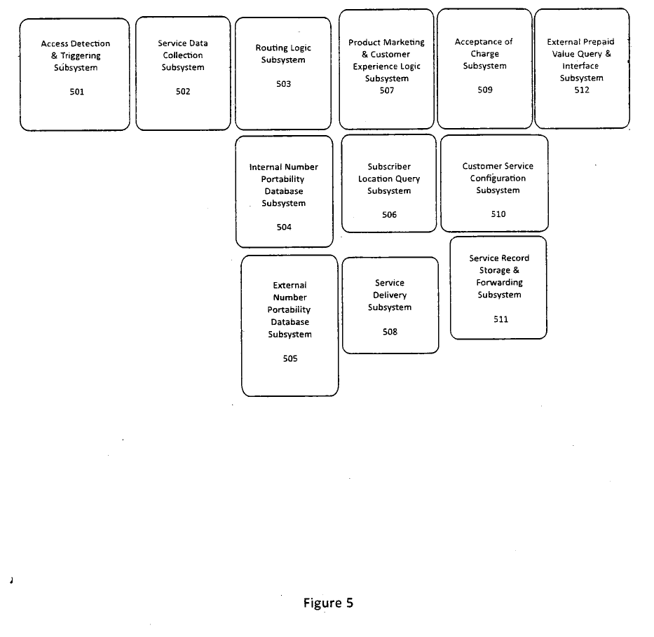

FIG. 5, illustrates the different components of the switching centre. The components include Access Detection & Triggering Subsystem (501), Service Data Collection Subsystem (502), Routing Logic Subsystem (503), Internal Number Portability Database Subsystem (504), External Number Portability Interface Subsystem (505), Subscriber Location Query Subsystem (506), Product Marketing & Customer Experience Logic Subsystem (507), Service Delivery Subsystem (508), Acceptance of Charge Subsystem (509), Customer Service Configuration Subsystem (510), Service Record Storage & Forwarding Subsystem (511), External Prepaid Value Query & Interface Subsystem (512).

The Access Detection & Triggering Subsystem (501) performs the detection of the initiation of a request for service which requires a Terminal Party or Sponsoring Tarty charging functionality. For voice calls, the event can be the call initiation signaling message (e.g. an IAM (initial address message) in an SS7 (signaling system number 7) network), or a SIP (Session Initiation Protocol) Invite message. The ADT subsystem initiates the sequence of workflow in the system. The Service Data Collection Subsystem (502) facilitates the collection of additional information necessary for the service logic to proceed to the next stage. E.g. in a Collect call (1st Party calls 2nd Party and 2nd Party pays), in the case of using a general service number for access (e.g. 1st Party calls a general number 3333), the SDC subsystem will essentially comprise of an IVR (interactive voice response) system playing an announcement and requesting the 1st Party to key in the actual 2nd Party's number), or the extraction of the Called number from the dialed access number with the Called party number altogether (e.g. 3333+Called party number) so that enough data is collected for the on-forward connection of the call, and for charging purposes. The same method applies for the extraction of 3^{rd} Party Sponsor number. The SDC subsystem can be an interface to application software such as a purpose build application running on smartphone operating systems. The Routing Logic Subsystem (503) determines which 2nd or 3rd Party network to inter-work for charging purposes and/or connection of calls. The RLS consults Internal Number Portability Database to determine which network to inter-work with. Internal Number Portability Database Subsystem (504) stores the associative numbers belonging to which destination network whereas the External Number Portability Database Interface Subsystem (505) interfaces with external database to query which network a particular subscriber belongs to.

The Subscriber Location Query Subsystem (506) queries the network to ensure that whether a particular subscriber is currently on the home network, or off the home network (roaming). This will be useful if we implement a policy of no reception of Collect call request while roaming. Location query can be deduced through MAP SRI (send routing information) message or other signaling means.

The Product Marketing & Customer Experience Logic Subsystem (507) determines the logic of the deduction and customer experience. An example of customer experience logic involves the display of the caller number, playing of language specific announcements and/or the playing of “you have no balance to receive the call, please top up to receive the call” reminders.

The Service Delivery Subsystem (508) is the subsystem to provide a particular service. For example, in the case of a Collect call on SIP it will be the gateways, session border controllers or softswitches. In the case of short message service, it will be the SMSC (short message service centre) for the mobile network.

The Acceptance of Charge Subsystem (509) handles the confirmation of whether a party wishes to accept the charges for a particular request of charge. In the case of a Collect call to the receiver this will be an interactive voice response system playing an announcement and requesting the receiver to confirm the acceptance of charges by way of speech recognition or pressing a key on a keypad to communicate with the system using DTMF (dual tone multi frequency). The acceptance of charge subsystem also handles implicit confirmation, i.e. if a subscriber through customer service confirmation has pre-approved the acceptance of charge then the IVR will not be played and the Collect call would be connected directly to the Called Party.

Customer Service Configuration Subsystem (510) interacts with the users of the system which would include the 1st, 2nd and 3rd parties, by way of IVR prompts, web interfaces, smart phone applications, USSD (Unstructured Supplementary Services Data) interactive menus, SMS, MMS and other means. The CSC subsystem facilitates user parties to configure options for the service and also to configure implicit or pre-approval logic to the acceptance of charge. For example, a 3rd party service sponsor may access the system through CSCS to pre-approve all acceptance of charges for telecommunication services requested by a particular 1st party.

The Service Record Storage & Forwarding Subsystem (511) handles the storage of service records, e.g. CDRs (Call Detail Records) for records and verification purposes and also to be forwarded to respective networks. This is particularly useful for the integration of billing data with the subscriber who are postpaid rather than prepaid. In the case of Diameter can be done using the Diameter Rf interface messages to Diameter enabled network.

The External Prepaid Value Query & Interface Subsystem (512) interface is an interface that signals the corresponding network to query for the prepaid balance of a concerned subscriber and to provide charging pulses and triggers to the corresponding network to deduct the prepaid value. It may also contains data pertaining to what are the charges for each block size in accordance to which network the origination of the request for service came from and the which network the terminal of the service is. This subsystem can be implemented based on protocols such as RADIUS, Diameter, CAMEL and and/or proprietary vendor specific protocols for the query and deduction of prepaid values. In the case of Diameter for deduction of prepaid values it can be done using the Diameter Ro interface messages to Diameter enabled network.

The invention also called as Called party or B-end or the service receiving (second party) or third party (sponsoring) deduction of values across multiple independently administered networks for services requested by the first party.

In case of voice calls, the invention is independent of the type of signaling method used, i.e. traditional PSTN (public switched telephone network), mobile or VOIP (voice over internet protocol).

The prepaid value in this invention although is explained in the context of paying for telecommunication services, it should be applied to other the payment for other goods, services and/or purposes.

The invention can also be applicable to post paid customers, where there is no need to check the prepaid balance of the Terminal customer.

As will be readily apparent to those skilled in the art, the present invention may easily be produced in other specific forms without departing from its essential characteristics. The present embodiments is, therefore, to be considered as merely illustrative and not restrictive, the scope of the invention being indicated by the claims rather than the foregoing description, and all changes which come within therefore intended to be embraced therein.

1. A method (300) for establishing a call from an Originating subscriber (206) in an Originating network (203) to a Terminal subscriber (207) in a Terminal network (204) comprising:
establishing a call by the Originating subscriber (206) in the Originating network (203) to the Terminal subscriber (207) in the Terminal network (204);
bridging the calls between the Originating network (203) and the Terminal network (204) via an automated Switching Centre (201); and
triggering the Terminal network (204) to charge the Terminal subscriber (207) for the call.

2. The method (300) of claim 1 further comprises determining the Terminal network information of the Terminal subscriber (207).

3. The method (300) of claim 1 further comprises determining roaming information of the Terminal subscriber (207).

4. The method (300) of claim 1, wherein the Terminal subscriber (207) pre-approves charging of the call from the Originating subscriber (206).

5. The method (300) of claim 1 wherein the Terminal subscriber (207) receives a prompt message for charging the call.

6. The method (300) of claim 1 further comprises sending a value deduction pulses or triggers to the Terminal subscriber (207) of Terminal network (204).

7. The method (300) of claim 1, wherein triggering the Terminal network (204) further comprises querying the Terminal network (204) for prepaid balance of the Terminal subscriber (207).

8. A method (400) for establishing a call from Originating subscriber (206) from an Originating network (203) to Terminal subscriber (207) from a Terminal network (204), sponsored by a third party from a Sponsor network (205), by an automated Switching Centre (201) comprising:
establishing a call by the Originating subscriber (206) at the Originating network (203) to the Terminal subscriber (207) at the Terminal network (204);
bridging the calls between the Originating network (203) and the Terminal network (204) via the automated Switching Centre (201); and
triggering the sponsor network (205) to charge the sponsor subscriber for the call.

9. The method (400) of claim 8 further comprises determining the Sponsor or Terminal network information of the Sponsor or Terminal subscriber (207) respectively.

10. The method (400) of claim 8 further comprises, determining roaming information of the Sponsor or Terminal subscriber (207).

11. The method (400) of claim 8 further comprises receiving confirmation from the Sponsor subscriber in a Sponsor network (205) for charging the call between Originating subscriber (206) and the Terminal subscriber (207).

12. The method of (400) claim 8 allowing the Terminal subscriber (207) to directly answer the call from the Originating subscriber (206) while charging the Sponsor subscriber in a Sponsor network (205).

13. The method (400) of claim 8 further comprises sending a value deduction pulses or triggers to the Sponsor subscriber of Sponsor network (205).

14. The method (400) of claim 8, wherein triggering the Sponsor network (205) further comprises querying the sponsoring network (205) for prepaid balance of the Sponsor subscriber.

15. A system (200) for establishing a call from an originating subscriber (206) in an Originating network (203) to a Terminal subscriber (207) in a Terminal network (204), wherein the terminal subscriber (207) is charged for the call, the system (200) comprising a Switching Centre (201) that communicates with VoIP gateways and TDM gateways or equivalent systems of the Originating network (203) and Terminal network (204).

16. The system (200) of claim 15, further comprises a Portability database (202) communicating with the Switching Centre (201), wherein the Portability database (202) stores information of the associated numbers to determine the Terminal network (204).

17. The system (200) of claim 16, wherein the Portability database (202) is a database external to the Switching Centre (201) or is located inside the Switching Centre (201).

18. The system (200) of claim 15 further comprises a sponsor gateway and sponsor TDM gateways or equivalent systems communicating with the Switching Centre (201) when a Sponsor party on a Sponsor network (205) sponsors the call.

19. The system (200) of claim 15, wherein the Switching Centre (201) further comprises:
an access Detection & Triggering Subsystem (501) that detects a request for initiation of service, e.g. a voice call and commences the service delivery and charging functions provided by the system;
a Service Data Collection Subsystem (502) that facilitates the collection of additional information necessary for the service logic to proceed to a next stage;
a Routing Logic Subsystem (503) that determines a network for charging purposes and for routing of calls to a selected network;
an acceptance of Charge Subsystem (509) that handles the confirmation by the Terminal or Sponsor party to accept the charges; and
an External Prepaid Value Query & Interface Subsystem (512) that queries a Sponsor network (205) or Terminal network (204) for the prepaid balance of the Sponsor or Terminal subscriber (207) for a particular request, and facilitating the charging of the service at the Terminal network (204) or Sponsor network (205).

20. The system (200) of claim 19, wherein the Switching Centre (201) further comprises:
a Subscriber Location Query Subsystem (506) to determine whether the Terminal subscriber (207) or Sponsor subscriber is in roaming;
a Customer Service Configuration Subsystem (510) that interacts with the users of the system (200) comprising the Originating (206), Sponsoring or Terminal subscribers (207), by way of IVR prompts, web interfaces, smart phone applications, USSD (Unstructured Supplementary Services Data) interactive menus, SMS, MMS and other means;
a Service Record Storage & Forwarding Subsystem (511) that handles the storage and forwarding of service records; and
a Product Marketing & Customer Experience Logic Subsystem (507) that determines deduction and customer experience.

21. The system (200) of claim 19, wherein the switching centre (201) further comprises an Internal Number Portability Database Subsystem (504) that stores the associative numbers belonging to the terminal network (204).

22. The system (200) of claim 19, wherein the switching centre (201) further comprises an External Number Portability Database Interface Subsystem (505) that interfaces with external database to enquire network of a particular subscriber.
